(19) United States
(12) Patent Application Publication
(10) Pub. No.: US 2023/0354377 A1
(43) Pub. Date: Nov. 2, 2023

(54) SIDELINK COMMUNICATIONS IN WIRELESS NETWORK

(71) Applicant: Nokia Technologies Oy, Espoo (FI)

(72) Inventors: Zhijie YANG, Shanghai (CN); Haiqin WU, Shanghai (CN)

(21) Appl. No.: 18/246,880

(22) PCT Filed: Sep. 30, 2020
(86) PCT No.: PCT/CN2020/119622

§ 371 Date: Mar. 28, 2023

(51) Int. Cl. H04W 72/25; H04W 28/02; H04W 76/14

(52) U.S. Cl. CPC H04W 72/25; H04W 28/0278; H04W 76/14

(57) ABSTRACT

This document discloses a solution for device-to-device communications. According to an aspect, a method comprises in a first terminal device: establishing an association with an access node; establishing a direct wireless link with a second, non-access-node, terminal device; causing transmission of a message to the access node, the message comprising a buffer status report and at least one information element indicating the direct wireless link; receiving, in response to the message, a trigger frame indicating a resource unit allocated to the direct wireless link; in response to the trigger frame, causing transmission of a data packet to the second terminal device over the direct wireless link in the allocated resource unit.

### FIELD

Various embodiments described herein relate to the field of wireless communications and, particularly, to direct device-to-device communication via a sidelink in a wireless network.

### BACKGROUND

A sidelink may refer to a peer-to-peer or device-to-device link between two terminal devices in a scenario where at least one of the terminal devices is further connected to an access node or a base station via another link. The sidelink may be employed to transfer data between the two devices without the need to route it via the access node, thus reducing latency with the reduction of a number of links used to deliver the data.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus for a first terminal device, comprising means for performing: establishing an association with an access node; establishing a direct wireless link with a second, non-access-node, terminal device; causing transmission of a message to the access node, the message comprising a buffer status report and at least one information element indicating the direct wireless link; receiving, in response to the message, a trigger frame indicating a resource unit allocated to the direct wireless link; and in response to the trigger frame, causing transmission of a data packet to the second terminal device over the direct wireless link in the allocated resource unit.

In an embodiment, the at least one information element indicating the direct wireless link comprises an identifier of the direct wireless link.

In an embodiment, the at least one information element indicating the direct wireless link comprises a channel quality indicator indicating a channel quality of the direct wireless link.

In an embodiment, the at least one information element indicating the direct wireless link comprises an indicator of a peer-to-peer transmission mode of the apparatus.

In an embodiment, the resource unit comprises a time-frequency transmission resource.

In an embodiment, the trigger frame comprises an information element indicating the direct wireless link.

In an embodiment, the means are further configured to perform: establishing a further direct wireless link with a third, non-access-node, terminal device; after transmitting the message and before receiving the trigger frame, transmitting a further message to the access node, the further message comprising a further buffer status report and at least one information element indicating the further direct wireless link, wherein the trigger frame indicates, in addition to the resource unit allocated to the direct wireless link, a further resource unit allocated to the further direct wireless link; in response to the trigger frame, causing transmission of a further data packet to the third terminal device over the further direct wireless link in the further resource unit.

In an embodiment, the resource unit and the further resource unit specify the same time resource but a different frequency resource or a different spatial multiplexing resource.

According to an aspect, there is provided an apparatus for an access node of a wireless network, comprising means for performing: establishing an association with a first terminal device; receiving a message from the first terminal device, the message comprising a buffer status report of the first terminal device and at least one information element indicating a direct wireless link between the first terminal device and a second terminal device; in response to the message, allocating a resource unit to the direct wireless link and causing transmission of a trigger frame to the first terminal device, the trigger frame indicating the resource unit and the direct wireless link.

In an embodiment, the means are further configured to perform: receiving from the first terminal device, a further buffer status report and at least one information element indicating a further direct wireless link; in response to the further buffer status report, allocating a further resource unit to the further direct wireless link, wherein the trigger frame indicates, in addition to the resource unit allocated to the direct wireless link, a further resource unit allocated to the further direct wireless link.

In an embodiment, the means are further configured to perform: establishing an association with a third terminal device; after receiving the message and before transmitting the trigger frame, receiving a further message from a third terminal device, the further message comprising a further buffer status report and at least one information element indicating a further direct wireless link between the third terminal device and the second terminal device; in response to the further message, allocating a further resource unit to the further direct wireless link, wherein the trigger frame indicates, in addition to the resource unit allocated to the direct wireless link, a further resource unit allocated to the further direct wireless link.

In an embodiment, the means are further configured to perform: establishing an association with a third terminal device; after receiving the message and before transmitting the trigger frame, receiving a further message from the third terminal device, the further message comprising a further buffer status report and at least one information element indicating a further direct wireless link between the third terminal device and a fourth terminal device; in response to the further message, allocating a further resource unit to the further direct wireless link, wherein the trigger frame indicates, in addition to the resource unit allocated to the direct wireless link, a further resource unit allocated to the further direct wireless link, wherein the resource unit and the further resource unit specify the same time resource but a different frequency resource or a different spatial multiplexing resource.

In an embodiment, the means are further configured to perform: establishing an association with a third terminal device; after receiving the message and before transmitting the trigger frame, receiving a further message from the third terminal device, the further message comprising a further buffer status report and at least one information element indicating an access link between the third terminal device and the access node; in response to the further message, allocating a further resource unit to the access link, wherein the trigger frame indicates, in addition to the resource unit allocated to the direct wireless link, the further resource unit allocated to the access link, wherein the resource unit and the further resource unit specify the same time resource but a different frequency resource or a different spatial multiplexing resource.

In an embodiment, the means described above comprises: at least one processor; and at least one memory including computer program code, the at least one memory and computer program code configured to, with the at least one processor, cause the performance of the apparatus.

According to an aspect, there is provided a method for a first terminal device, comprising: establishing, by the first terminal device, an association with an access node; establishing, by the first terminal device, a direct wireless link with a second, non-access-node, terminal device; causing by the first terminal device transmission of a message to the access node, the message comprising a buffer status report and at least one information element indicating the direct wireless link; receiving, by the first terminal device in response to the message, a trigger frame indicating a resource unit allocated to the direct wireless link; in response to the trigger frame, causing by the first terminal device transmission of a data packet to the second terminal device over the direct wireless link in the allocated resource unit.

In an embodiment, the at least one information element indicating the direct wireless link comprises an identifier of the direct wireless link.

In an embodiment, the at least one information element indicating the direct wireless link comprises a channel quality indicator indicating a channel quality of the direct wireless link.

In an embodiment, the at least one information element indicating the direct wireless link comprises an indicator of a peer-to-peer transmission mode of the apparatus.

In an embodiment, the resource unit comprises a time-frequency transmission resource.

In an embodiment, the trigger frame comprises an information element indicating the direct wireless link.

In an embodiment, the method further comprises as performed by the first terminal device: establishing a further direct wireless link with a third, non-access-node, terminal device; after transmitting the message and before receiving the trigger frame, transmitting a further message to the access node, the further message comprising a further buffer status report and at least one information element indicating the further direct wireless link, wherein the trigger frame indicates, in addition to the resource unit allocated to the direct wireless link, a further resource unit allocated to the further direct wireless link; in response to the trigger frame, causing transmission of a further data packet to the third terminal device over the further direct wireless link in the further resource unit.

In an embodiment, the resource unit and the further resource unit specify the same time resource but a different frequency resource or a different spatial multiplexing resource.

According to an aspect, there is provided a method for an access node of a wireless network, comprising: establishing, by the access node, an association with a first terminal device; receiving by the access node a message from the first terminal device, the message comprising a buffer status report of the first terminal device and at least one information element indicating a direct wireless link between the first terminal device and a second terminal device; in response to the message, allocating by the access node a resource unit to the direct wireless link and causing transmission of a trigger frame to the first terminal device, the trigger frame indicating the resource unit and the direct wireless link.

In an embodiment, the method further comprises as performed by the access node: receiving from the first terminal device, a further buffer status report and at least one information element indicating a further direct wireless link; in response to the further buffer status report, allocating a further resource unit to the further direct wireless link, wherein the trigger frame indicates, in addition to the resource unit allocated to the direct wireless link, a further resource unit allocated to the further direct wireless link.

In an embodiment, the method further comprises as performed by the access node: establishing an association with a third terminal device; after receiving the message and before transmitting the trigger frame, receiving a further message from a third terminal device, the further message comprising a further buffer status report and at least one information element indicating a further direct wireless link between the third terminal device and the second terminal device; in response to the further message, allocating a further resource unit to the further direct wireless link, wherein the trigger frame indicates, in addition to the resource unit allocated to the direct wireless link, a further resource unit allocated to the further direct wireless link.

In an embodiment, the method further comprises as performed by the access node: establishing an association with a third terminal device; after receiving the message and before transmitting the trigger frame, receiving a further message from the third terminal device, the further message comprising a further buffer status report and at least one information element indicating a further direct wireless link between the third terminal device and a fourth terminal device; in response to the further message, allocating a further resource unit to the further direct wireless link, wherein the trigger frame indicates, in addition to the resource unit allocated to the direct wireless link, a further resource unit allocated to the further direct wireless link, wherein the resource unit and the further resource unit specify the same time resource but a different frequency resource or a different spatial multiplexing resource.

In an embodiment, the method further comprises as performed by the access node: establishing an association with a third terminal device; after receiving the message and before transmitting the trigger frame, receiving a further message from the third terminal device, the further message comprising a further buffer status report and at least one information element indicating an access link between the third terminal device and the access node; in response to the further message, allocating a further resource unit to the access link, wherein the trigger frame indicates, in addition to the resource unit allocated to the direct wireless link, the further resource unit allocated to the access link, wherein the resource unit and the further resource unit specify the same time resource but a different frequency resource or a different spatial multiplexing resource.

According to an aspect, there is provided a computer program product embodied on a computer-readable medium and comprising a computer program code readable by a computer for a first network node of a wireless network, wherein the computer program code configures the computer to carry out a computer process in a first terminal device, the computer process comprising: establishing an association with an access node; establishing a direct wireless link with a second, non-access-node, terminal device; causing transmission of a message to the access node, the message comprising a buffer status report and at least one information element indicating the direct wireless link; receiving, in response to the message, a trigger frame indicating a resource unit allocated to the direct wireless link; in response to the trigger frame, causing transmission of a data packet to the second terminal device over the direct wireless link in the allocated resource unit.

In an embodiment, the computer program product further comprises a computer program code configuring the computer to carry out all the steps of the method according to any one of the embodiments described above for the first terminal device.

According to an aspect, there is provided a computer program product embodied on a computer-readable medium and comprising a computer program code readable by a computer for a first network node of a wireless network, wherein the computer program code configures the computer to carry out a computer process in an access node, the computer process comprising: establishing an association with a first terminal device; receiving a message from the first terminal device, the message comprising a buffer status report of the first terminal device and at least one information element indicating a direct wireless link between the first terminal device and a second terminal device; in response to the message, allocating a resource unit to the direct wireless link and causing transmission of a trigger frame to the first terminal device, the trigger frame indicating the resource unit and the direct wireless link.

In an embodiment, the computer program product further comprises a computer program code configuring the computer to carry out all the steps of the method according to any one of the embodiments described above for the access node.

### LIST OF DRAWINGS

Embodiments are described below, by way of example only, with reference to the accompanying drawings, in which

FIG. 1 illustrates a wireless communication scenario to which some embodiments of the invention may be applied;

FIGS. 2 and 3 illustrate embodiments of processes for enabling trigger-based sidelink communications;

FIGS. 4 and 5 illustrate an embodiment combining the embodiments of FIGS. 2 and 3;

FIGS. 6 and 7 illustrate an embodiment where a terminal device transmits data packets over multiple sidelinks in a trigger-based manner simultaneously;

FIGS. 8 and 9 illustrate an embodiment where a terminal device receives data packets over multiple sidelinks in a trigger-based manner simultaneously;

FIGS. 10 and 11 illustrate an embodiment where two sidelinks are allocated to transmit simultaneously in a trigger-based manner;

FIGS. 12 to 14 illustrate an embodiment where a sidelink and an access link are allocated to transmit simultaneously in a trigger-based manner; and

FIGS. 15 and 16 illustrate block diagrams of structures of apparatuses according to some embodiments.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

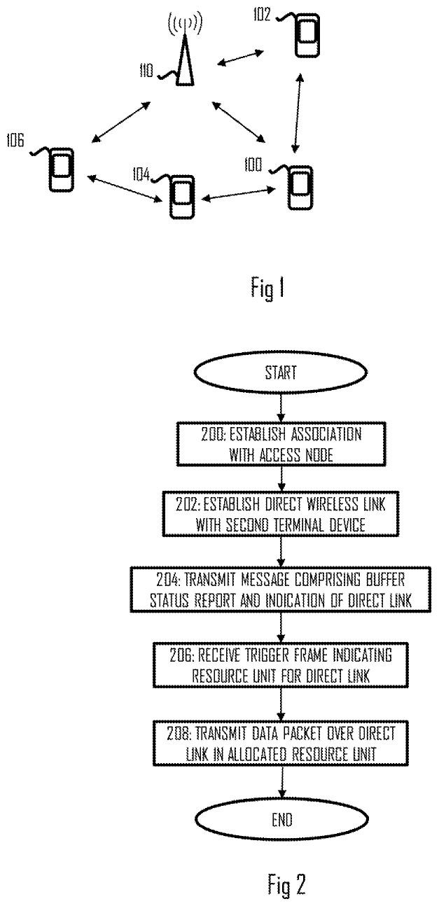

A general wireless communication scenario to which embodiments of the invention may be applied is illustrated in FIG. 1. FIG. 1 illustrates wireless communication devices comprising an access point (AP) 110 and a plurality of wireless terminal devices or stations (STA) 100, 102, 104, 106. The AP may be associated with a basic service set (BSS) which is a basic building block of an IEEE 802.11 wireless local area network (WLAN). The most common BSS type is an infrastructure BSS that includes a single AP together with all STAs associated with the AP. The AP may be a fixed AP or it may be a mobile AP, and a general term for an apparatus managing a wireless network such as the BSS and providing the stations with wireless services is an access node. The AP 110 may also provide access to other networks, e.g. the Internet. In another embodiment, the BSS may comprise a plurality of APs to form an extended service set (ESS), e.g. the AP 110 may belong to the same ESS with another AP and have the same service set identifier (SSID). While embodiments of the invention are described in the context of the above-described topologies of IEEE 802.11 based networks, it should be appreciated that these or other embodiments of the invention may be applicable to networks based on other specifications, e.g. different versions of the IEEE 802.11, WiMAX (Worldwide Interoperability for Microwave Access), UMTS LTE (Long-term Evolution for Universal Mobile Telecommunication System), the fifth generation cellular communication systems, and other networks having cognitive radio features, e.g. transmission medium sensing features and adaptiveness to coexist with radio access networks based on different specifications and/or standards.

IEEE 802.11n specification specifies a data transmission mode that includes 20 megahertz (MHz) wide primary and secondary channels. The primary channel is used in all data transmissions with clients supporting only the 20 MHz mode and with clients supporting higher bandwidths. A further definition in 802.11n is that the primary and secondary channels are adjacent. The 802.11n specification also defines a mode in which a STA may, in addition to the primary channel, occupy one secondary channel which results in a maximum bandwidth of 40 MHz. IEEE 802.11ac amendment extends such an operation model to provide for wider bandwidths by increasing the number of secondary channels from 1 up to 7, thus resulting in bandwidths of 20 MHz, 40 MHz, 80 MHz, and 160 MHz. A 40 MHz transmission band may be formed by two contiguous 20 MHz bands, and an 80 MHz transmission band may be formed by two contiguous 40 MHz bands. However, a 160 MHz band may be formed by two contiguous or non-contiguous 80 MHz bands. These principles apply to other 802.11 specifications as well, e.g. 802.11ax.

Some IEEE 802.11 networks employ channel contention based on carrier sense multiple access with collision avoidance (CSMA/CA) for channel access. The CSMA/CA is an example of a physical carrier sensing function to determine whether the first channel and the second channel, respectively, is busy or idle. Every device attempting to gain a transmission opportunity (TXOP) is reducing a backoff value while the primary channel is sensed to be idle for a certain time interval. The backoff value may be selected randomly within a range defined by a contention window parameter. The contention window may have different ranges for different types of traffic, thus affecting priority of the different types of traffic. The channel sensing may be based on sensing a level of radio energy in the radio channel. The sensed level may be compared with a threshold: if the sensed level is below the threshold level, the channel may be determined to be idle (otherwise busy). Such a procedure is called clear channel assessment (CCA) in 802.11 specifications. When the backoff value reaches zero, the device gains the TXOP and starts frame transmission. If another device gains the TXOP before that, the backoff value computation may be suspended, and the device continues the backoff computation after the TXOP of the other device has ended and the primary channel is sensed to be idle. The time duration (the backoff value) may not be decremented during the TXOP of the other device, but the time duration that already lapsed before the suspension may be maintained, which means that the device now has a higher probability of gaining the TXOP. Once the device wins the channel contention and gains access to the channel, it may transmit a frame that defines a reservation period for the channel access. The reservation period may be defined by a duration field in the frame. Upon detecting the reservation period from the frame, any other device contending on the same channel may set a network allocation vector (NAV) for the duration of the reservation period and refrain the contention on the channel for the duration of the reservation period. The use of NAV for determining that the channel is busy is called virtual carrier sensing in some literature.

When performing the channel contention, a device may employ different access parameters for the different frames. The differing access parameters may comprise quality-of-service (QoS) parameters such as enhanced distributed channel access (EDCA) parameters of IEEE 802.11 technology. The EDCA parameters may comprise a plurality of access categories (AC) for prioritizing frame transmissions. The access categories may comprise the following priority levels in the order of increasing priority: background (AC_BK), best effort (AC_BE), video streaming (AC_VI), and voice (AC_VO). A higher priority frame transmission may use a shorter contention window and a shorter arbitration inter-frame spacing (AIFS) that result in higher probability of gaining the TXOP.

The STA 100 to 106 may be considered to be a terminal device or a station capable of connecting or associating to the AP 110 and/or to other APs. The STA may establish a connection with any one of APs it has detected to provide a wireless connection within the neighbourhood of the STA. The connection establishment may include authentication in which an identity of the STA is established in the AP. The authentication may comprise setting up an encryption key used in the BSS. After the authentication, the AP and the STA may carry out association in which the STA is fully registered in the BSS, e.g. by providing the STA with an association identifier (AID). A separate user authentication may follow association, which may also comprise building an encryption key used in the BSS. It should be noted that in other systems terms authentication and association are not necessarily used and, therefore, the association of the STA to an AP should be understood broadly as establishing a connection between the STA and the AP such that the STA is in a connected state with respect to the AP and waiting for downlink frame transmissions from the AP and monitoring its own buffers for uplink frame transmissions. A STA not associated to the AP is in an unassociated state. An unassociated STA may still exchange some frames with the AP, e.g. discovery frames.

IEEE 802.11 specifications define also peer-to-peer links that may be understood as direct device-to-device links or sidelinks described in Background. In FIG. 1, the sidelinks are illustrates by the arrows between the terminal devices. The terminal device 100 may have established a sidelink with the terminal device 102 or 104, or sidelinks with both 102 and 104, while the terminal device 104 may have another sidelink with the terminal device 106. All terminal devices may have further established an association with the access node 110. Similar sidelinks are defined in LTE and 5G specifications of the 3GPP (3rd Generation Partnership Project), although the protocols are different. It should be appreciated that a sidelink in the context of the present description may refer to a sidelink of the 3GPP specifications, a peer-to-peer link of the 802.11 specifications, or to any other direct wireless link between two terminal devices, e.g. non-access-node terminal devices (such as the STA in the 802.11 specifications). In the 802.11 specifications, the sidelink may be established according to a tunnelled direct link setup (TDLS) protocol that enables data transmission from one peer device to another peer device over a direct sidelink without a need to route the data via an access node serving the peer devices, thus improving throughput and reducing latency. However, further latency improvements to the throughput and latency may be advantageous.

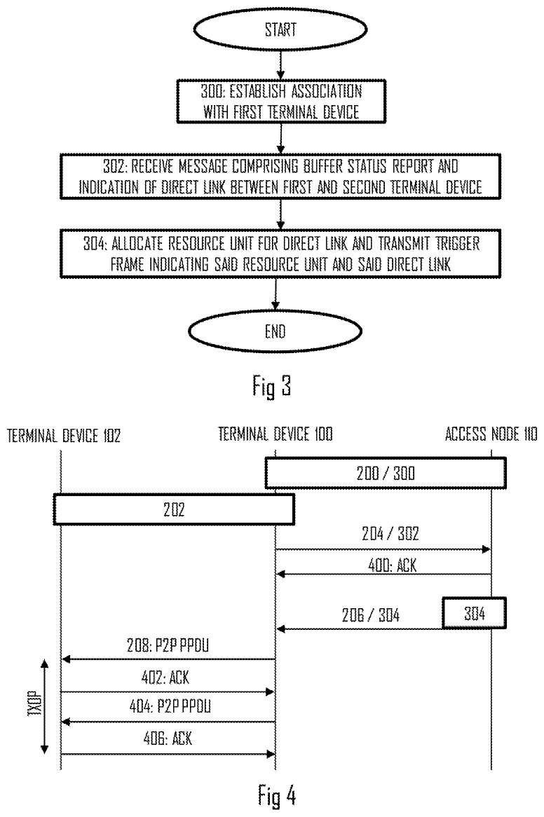

FIGS. 2 and 3 illustrate some embodiments for controlled sidelink transmissions. FIG. 2 illustrates a procedure for a terminal device, e.g. any one of the terminal devices 100 to 106, while FIG. 3 illustrates a procedure for the access node 110 of a wireless network.

Referring to FIG. 2, the procedure performed by the terminal device comprises: establishing an association with an access node (block 200); establishing a direct wireless link with a second, non-access-node, terminal device (block 202); causing transmission of a message to the access node, the message comprising a buffer status report and at least one information element indicating the direct wireless link (block 204); receiving (block 206), in response to the message, a trigger frame indicating a resource unit allocated to the direct wireless link; and in response to the trigger frame, causing transmission of a data packet to the second terminal device over the direct wireless link in the allocated resource unit (block 208).

Referring to FIG. 3, the procedure performed by the access node comprises: establishing (block 300) an association with a first terminal device; receiving (block 302) a message from the first terminal device, the message comprising a buffer status report of the first terminal device and at least one information element indicating a direct wireless link between the first terminal device and a second terminal device; in response to the message, allocating a resource unit to the direct wireless link and causing transmission of a trigger frame to the first terminal device, the trigger frame indicating the resource unit and the direct wireless link (block 304).

With the introduction of trigger-based scheduled transmissions, adverse effects of channel contention may be reduced, in particular when the number of contending terminal devices increase, thus improving throughput and latency in the sidelink(s).

In an embodiment, the access node advertises its capability of supporting trigger-based sidelink transmissions. The access node may transmit, in a capability field of a beacon frame or another advertisement frame, an information element indicating the support for the trigger-based sidelink transmissions.

In an embodiment, the buffer status report is comprised as a field or as an information element in the message.

In an embodiment, the buffer status report comprises the at least one information element indicating the direct wireless link.

In an embodiment, the message carries multiple buffer status reports, as described in greater detail below. The multiple buffer status reports may alternatively be carried by different messages transmitted by the same terminal device or transmitted by different terminal devices, as also described in the embodiments below.

In an embodiment, the at least one information element indicating the direct wireless link comprises a channel quality indicator indicating a channel quality of the direct wireless link. The access node may use the channel quality indicator in the resource allocation.

In an embodiment, the message carrying the buffer status report is management frame, a null frame, or a data frame. In an embodiment applicable to 802.11 specifications, the STA may include a buffer status report (BSR) Control subfield in a quality-of-service (QoS) Data or QoS Null frame. In this case, Queue Size subfield in the QoS Control field and the Queue Size High and Queue Size All subfields in the BSR Control subfield might differ, and any of the three subfields may be set to 255 to indicate unspecified or unknown queue size. The STA may include only the BSR Control subfield in a Management frame. Further referring to 802.11 specifications, a field carrying the buffer status report has the following structure:

| ACI | Delta | ACI | Scaling | Queue | Queue | P2P | Target |
|---|---|---|---|---|---|---|---|
| Bitmap | TID | High | Factor | Size High | Size All | Mode | AID |
| 4 bits | 2 bits | 2 bits | 2 bits | 8 bits | 8 bits | 1 bit | 12 bits |

Where ACI refers to an access category indicator, TID refers to a traffic indicator, and P2P refers to peer-to-peer. When a buffer status report has the P2P mode having one value, it may refer to a conventional uplink transmission from a terminal device to the access node 110, and when the P2P mode has the other value, it refers to P2P transmission. In the former case, Target AID field may be omitted because of the uplink transmission. In the latter case, Target AID may indicate the sidelink for which the data transmission is to be carried out.

The buffer status report may indicate a status of a transmission data buffer of the terminal device transmitting the buffer status report. The buffer status report may be an indicator to the access node that there is a need to transmit data in a trigger-based manner, e.g. data transmission responsive to a trigger frame transmitted by the access node.

Further referring to the embodiment of 802.11 specifications, a user information (User Info) field of the trigger frame may have the following structure:

| | | UL | | | SS | | | | |
|---|---|---|---|---|---|---|---|---|---|
| | | FEC | UL | | Allocation/ | UL | | | Trigger |
| | RU | Coding | HE- | UL | RA-RU | Target | P2P | Target | Dependent |
| AID | Allocation | Type | MCS | DCM | Information | RSSI | Mode | AID | User Info |
| 12 bits | 8 bits | 1 bit | 4 bits | 1 bit | 6 bits | 7 bits | 1 bit | 12 bits | variable |

where RU refers to a resource unit, UL refers to uplink, FEC refers to forward error coding, HE-MCS refers to high-efficiency modulation and coding scheme, SS refers to spatial stream, RA-RU refers to random access resource unit, and RSSI refers to received signal strength indicator. The association identifier may indicate the association with the access node while the target AID may be the AID of the sidelink. The information elements P2P mode and the target AID may follow the logic described above for the BSR field. When the trigger frame indicates a resource unit for a sidelink, the P2P may have one value and the target AID field may indicate the sidelink. When the trigger frame indicates a resource unit for uplink transmission, the P2P mode may have the other value and the target AID field may be omitted.

In an embodiment, the at least one information element indicating the direct wireless link in blocks 204 and 302 comprises an identifier of the direct wireless link (the sidelink), e.g. the association identifier of the direct wireless link (Target AID in the buffer status report above).

In an embodiment, the at least one information element indicating the direct wireless link in blocks 204 and 302 is an indicator of a peer-to-peer transmission mode (the P2P Mode bit in the buffer status report above).

In an embodiment, the resource unit comprises a time-frequency transmission resource. The frequency transmission resource may be defined by the RU Allocation field, for example, in terms of a channel index, a set of channel indices and/or a bandwidth. The time resource may be defined by the transmission time of the trigger frame and a duration field specifying a duration the allocated frequency resource is reserved to the terminal device. In an embodiment following 802.11 specifications, the resource unit may comprise a random access resource unit (RA-RU) that may be defined as a resource unit (RU) allocated in a Trigger frame to support the uplink (UL) orthogonal frequency division multiple access (OFDMA) based random access (UORA) procedure. Such a resource unit (RU) may be formed by a group of 26, 52, 106, 242, 484, 996, 2×996,52+26, 106+26, 484+242, 996+484, 2×996+484, 3×996+484, 3×996 or 4×996, subcarriers as an allocation of subcarriers for transmission. A transmission opportunity of the terminal device may start after a determined time after the trigger frame, e.g. a short inter-frame space (SIFS) of 802.11 specifications. In another embodiment, the resource unit specifies a spatial resource according to spatial multiplexing, e.g. specific precoding coefficients defining a dedicated spatial communication resource.

In an embodiment, the trigger frame comprises an information element indicating the direct wireless link, e.g. the association identifier of the direct wireless link (Target AID in the User Info field above).

In an embodiment, the direct wireless link is established according to the tunnelled direct link setup (TDLS) protocol of 802.11 specifications.

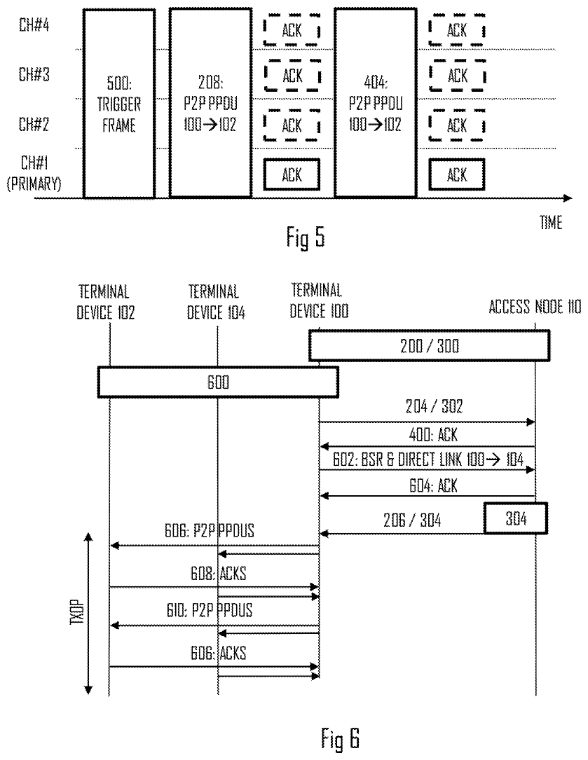

Let us then describe some embodiments of the processes of FIGS. 2 and 3. FIGS. 4 and 5 illustrate an embodiment combining the processes of FIGS. 2 and 3. In FIG. 4, the steps or functions denoted by the same reference numbers as in FIGS. 2 and 3 represent the same or substantially similar functions. Accordingly, the access node 110 and the terminal device 100 establish an association in steps 200 and 300 in the above-described manner. Furthermore, the terminal devices 100 and 102 establish the direct wireless link (the sidelink) in step 202. Thereafter, the terminal device transmits the buffer status report to the access node in step 204. The buffer status report indicating the direct wireless link, e.g. with the association identifier of the direct wireless link, may serve as a request for allocating a resource unit to the direct wireless link. The request may be called a request to send a trigger-based peer-to-peer PPDU to the terminal device 102 specified with the association identifier.

The access node may acknowledge (ACK) the reception of the message carrying the buffer status report in step 400. Thereafter, the access node may perform the allocation of the resource unit to the direct wireless link (block 304) and transmit the trigger frame indicating the allocated resource unit in block 304. Upon receiving the trigger frame in step 206 and detecting that the resource unit has been allocated to the direct wireless link, the terminal device may perform transmission of the data packet in step 208. The data packet may comprise a physical layer protocol data unit (PPDU). The transmission in step 208 denotes a start of a transmission opportunity (TXOP) of the terminal device. During the TXOP, the terminal device 100 may transmit multiple PPDUs (step 404), provided that a predefined duration of the TXOP is long enough for the multiple frame transmissions by the terminal device 100. The duration may be specified in the trigger frame, e.g. by Duration field specified in 802.11 specifications. The terminal device 102 receiving the PPDU(s) may acknowledge the reception of the PPDU(s) in steps 402 and 406.

FIG. 5 illustrates the resource units allocated to the P2P TXOP in an embodiment of FIG. 4. The trigger frame 500 transferred in steps 206/304 may indicate that channels 1 to 4 are all allocated to the terminal device. For example, the RU Allocation field may specify ‘67’ which indicates that an 80 Megahertz (MHz) band has been allocated. This together with the P2P Mode indicator and the AID of the direct wireless link indicates that the 80 Megahertz (MHz) band has been allocated to the direct wireless link between the terminal devices 100 and 102. Accordingly, the terminal device 100 may transmit the P2P PPDU on channels 1 to 4, each having a 20 MHz bandwidth. Channel 1 is denoted here as the primary channel of the wireless network while the channels 2 to 4 are secondary channels. In an embodiment, the terminal device acknowledges the reception of the PPDU on all channels 1 to 4. In another embodiment, the terminal device transmits the acknowledgment only on the primary channel 1. The acknowledgment may indicate a single data packet or it may be a block acknowledgment acknowledging multiple data packets. It may equally be a multi-STA block acknowledgment or a multi-TID (traffic identifier) block acknowledgment of the 802.11 specifications. The subsequent PPDU transmission in step 404 may be performed in the same manner.

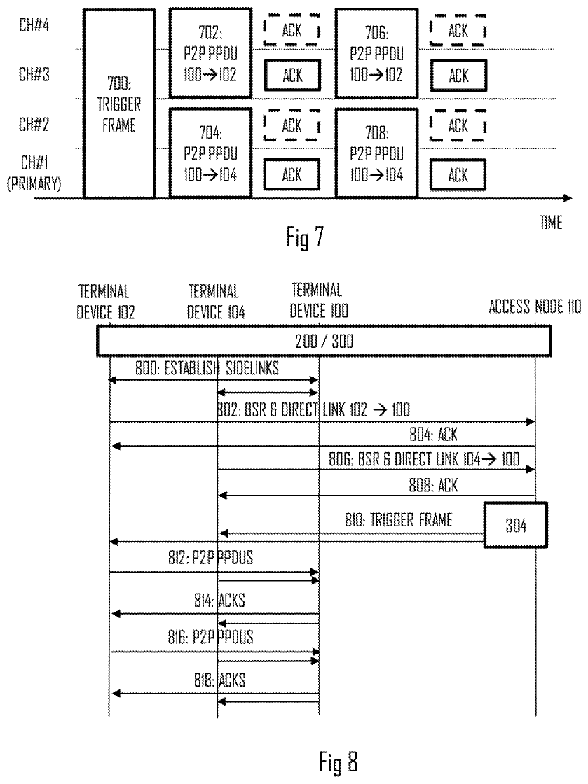

FIGS. 6 and 7 illustrate an embodiment where the terminal device 100 requests for transmission over two direct wireless links: a first direct wireless link with the terminal device 102 and a second direct wireless link with the terminal device 104. Referring to FIG. 6, the terminal device 100 may establish the first and second direct wireless links in block 600, e.g. according to the TDLS protocol. The terminal device 100 may then transmit a buffer status report for the first direct wireless link in step 204, as described above. After this buffer status report and before the trigger frame, the terminal device 100 may transmit a further message comprising a further buffer status report and at least one information element indicating the second direct wireless link (step 602), and the access node 110 may acknowledge the message in step 604. Now, the terminal device 100 has requested for the resource unit allocation to two direct wireless links, and the access node may perform the allocations of the resource units to the first and second direct wireless link in block 304 and transmit a trigger frame indicating the resource unit allocations in step 304.

In an embodiment, the terminal device 100 transmits the second buffer status report (step 602) after a distributed coordination function inter-frame space (DIFS of 802.11 specifications) has elapsed from the reception of the acknowledgment in step 400. In other words, upon detecting that the DIFS has passed from the reception of the acknowledgment, the terminal device 100 may start channel contention to transmit the second buffer status report. Similarly, the DIFS may be applied to the transmission of the trigger frame, e.g. the trigger frame may be transmitted after the DIFS has passed from the transmission of the acknowledgment in step 604.

Upon receiving the trigger frame, the terminal device 100 may extract the resource unit allocations from the trigger frame and transmit PPDUs to the terminal devices 102, 104 over the respective direct wireless links and in the allocated resource units in step 606. The terminal devices may acknowledge the receptions of the PPDUs in step 608. As described above, if the duration of the TXOP allows, the terminal device 100 may transmit further PPDUs in the allocated resource unit.

Referring to FIG. 7, the access node 102 may allocate parallel frequency channels to the two direct wireless links. The trigger frame 700 transmitted in step 304 may comprise a duration field specifying the duration of the TXOP allocated to the two direct wireless links. The same TXOP may be applied to the two direct wireless links. As described above, the trigger frame may comprise two resource unit allocations, sharing the same Duration. The first direct wireless link may be identified with the association identifier of the first direct wireless link, and a RU Allocation field may be set to ‘66’, for example, meaning a 40 MHz bandwidth formed by the channels 3 and 4 is allocated to the PPDU(s) to the terminal device 102. The second direct wireless link may be identified with the association identifier of the second direct wireless link, and a RU Allocation field may be set to ‘65’, for example, meaning that another 40 MHz bandwidth, formed by channels 1 and 2 is allocated to the PPDU(s) to the terminal device 104. In other embodiments, the channels and bandwidths may differ. Accordingly, the terminal device 100 may transmit a first PPDU 702 to the terminal device 102 on channels 3 and 4 and a second PPDU 704 to the terminal device 104 on channels 1 and 2. The terminal devices 102 and 104 may acknowledge the reception of the PPDUs on the respective channels or on one of the channels where the PPDUs 702, 704 were received. If the duration allows, the terminal device 100 may transmit further PPDUs 906, 908 in an analogous manner.

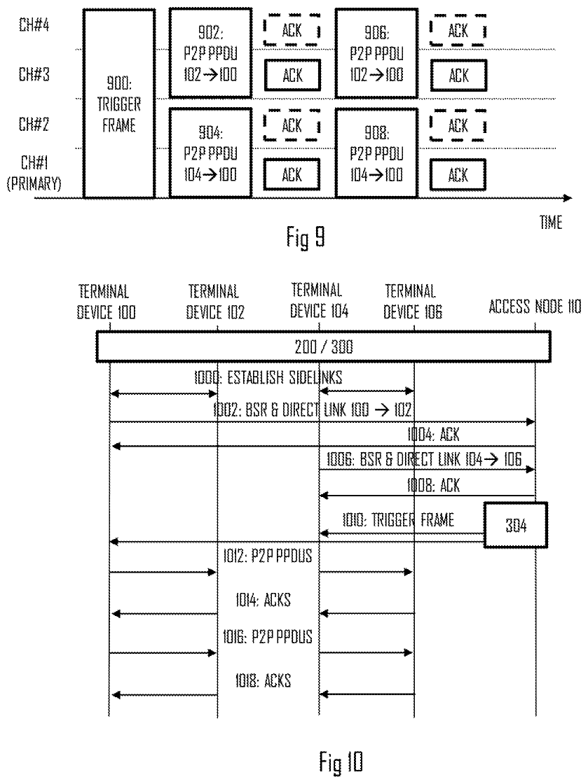

FIGS. 8 and 9 illustrates an embodiment that is reversed with respect to the embodiment of FIGS. 6 and 7. In this embodiment, the terminal devices 102 and 104 transmit the data to the terminal device 100 via the same direct wireless links as in the embodiment of FIGS. 6 and 7. Referring to FIG. 8, the first and second direct wireless links may be established in the same manner as in the embodiment of FIG. 6 (step 800). In a situation where the terminal devices 102, 104 both have data to transmit to the terminal device 100, the terminal devices 102, 104 may both transmit respective buffer status reports to the access node (steps 802 and 806), and the access node may acknowledge the reception of the buffer status reports (steps 804 and 808, respectively). The terminal device 102 may first get the opportunity to send a message comprising the buffer status report in step 802. The buffer status report may comprise the indicator that indicates the direct wireless link between the terminal devices 100 and 102, e.g. the association identifier of the direct wireless link. Thereafter, e.g. after a DIFS has expired from the acknowledgment in step 804, the terminal device 104 may get the opportunity to send a message comprising the buffer status report in step 806. The buffer status report may comprise the indicator that indicates the direct wireless link between the terminal devices 100 and 104, e.g. the association identifier of the direct wireless link. Upon receiving the multiple buffer status reports indicating the different wireless links and the same terminal device 100, the access node may perform allocation of resource units to the direct wireless links and transmit a trigger frame comprising multiple resource unit allocations: one for the first direct wireless link between 100 and 102 and one for the second direct wireless link between 100 and 104. As described above, each resource unit allocation may be identified in the trigger frame by the respective association identifier.

Upon receiving the trigger frame, the terminal device 102 may detect, on the basis of the detection of the association identifier of the first direct wireless link, that the trigger frame comprises a resource unit allocation to the first direct wireless link and determines the resource unit allocated to it. Similarly upon receiving the trigger frame, the terminal device 104 may detect, on the basis of the detection of the association identifier of the second direct wireless link, that the trigger frame comprises a resource unit allocation to the second direct wireless link and determines the resource unit allocated to it. Accordingly, the terminal devices 102 and 104 may transmit PPDUs to the terminal device 100 in the allocated resource units (step 812). The terminal device 100 may acknowledge the reception of the PPDU(s) in step 814, and further PPDUs and respective acknowledgments may be transmitted in steps 816 and 818, if the duration of the TXOP(s) allows it.

The terminal devices may both have a TXOP simultaneously but in different frequency and/or spatial resources, as illustrated in FIG. 9. As described above, the trigger frame (900 in FIG. 9) transmitted in step 810 may comprise at least two resource unit allocations, sharing the same duration. The first direct wireless link may be identified with the association identifier of the first direct wireless link, and a RU Allocation field may be set to ‘66’, for example, meaning a 40 MHz bandwidth formed by the channels 3 and 4 is allocated to the PPDU(s) transmitted by the terminal device 102. The second direct wireless link may be identified with the association identifier of the second direct wireless link, and a RU Allocation field may be set to ‘65’, for example, meaning that another 40 MHz bandwidth, formed by channels 1 and 2 is allocated to the PPDU(s) transmitted by the terminal device 104. In other embodiments, the channels and bandwidths may differ. Accordingly, the terminal device 102 may transmit a first PPDU 902 to the terminal device 100 on channels 3 and 4, and the terminal device 104 may transmit, simultaneously, a second PPDU 904 to the terminal device 100 on channels 1 and 2. The terminal device 100 may acknowledge the reception of the PPDUs on the respective channels or on one of the channels where the respective PPDUs 902, 904 were received. If the duration allows, the terminal devices 102, 104 may transmit further PPDUs 906, 908 in an analogous manner.

In summary, in the embodiment of FIGS. 8 and 9 the access node receives, multiple buffer status reports indicating multiple sidelinks and allocates a unique resource unit to each sidelink. The resource units may be arranged to have the same timing, e.g. a start time and duration. Thereafter, the access node may add the resource unit allocations to the same trigger frame.

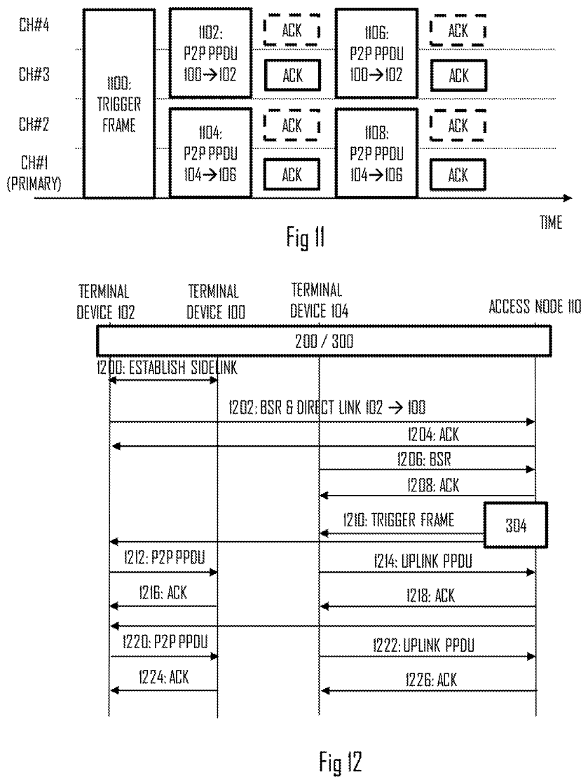

FIGS. 10 and 11 illustrate an embodiment for a situation where the terminal devices 100 and 102 have a first direct wireless link established therebetween, and the terminal devices 104 and 106 have a second direct wireless link established therebetween. In this embodiment, the access node 110 receives buffer status reports for both direct wireless links, allocates a resource unit to both direct wireless links and indicates the resource unit allocation in a trigger frame. Referring to FIG. 10, the first and second direct wireless links may be established in step 1000 in the above-described manner. Upon determining to transmit data to the terminal device 102, the terminal device 100 may transmit the message comprising the buffer status report to the access node and indicate the first direct wireless link in the buffer status report (step 1002). The access node may acknowledge the message in step 1004. Thereafter, e.g. upon expiry of the DIFS from the acknowledgment in step 1004, the terminal device 104 also needing to transfer data, to the terminal device 106 over the second direct wireless link, may transmit a message comprising a buffer status report of the terminal device 104 and indicating the second direct wireless link (step 1006). The access node may acknowledge reception of this message as well (step 1008).

Upon receiving the multiple buffer status reports from the terminal devices 100 and 104, indicating the respective direct wireless links, the access node 110 may perform allocation of resource units to the direct wireless links and transmit a trigger frame (step 1010) comprising multiple resource unit allocations: one for the first direct wireless link and the terminal device 100 and one for the second direct wireless link and the terminal device 104. As described above, each resource unit allocation may be identified in the trigger frame by the respective association identifier.

Upon receiving the trigger frame in step 1010, the terminal device 100 may detect, on the basis of the detection of the association identifier of the first direct wireless link, that the trigger frame comprises a resource unit allocation to the first direct wireless link and determines the resource unit allocated to it. Similarly upon receiving the trigger frame, the terminal device 104 may detect, on the basis of the detection of the association identifier of the second direct wireless link, that the trigger frame comprises a resource unit allocation to the second direct wireless link and determines the resource unit allocated to it. Accordingly, the terminal devices 100 and 104 may transmit PPDUs to the respective terminal devices 102 and 106 in the allocated resource units (step 1012). The terminal devices 102 and 106 may acknowledge the reception of the PPDUs in step 1014, and further PPDUs and respective acknowledgments may be transmitted in steps 1016 and 1018, if the durations of the TXOPs allow it.

The terminal devices 100, 104 may both have a TXOP simultaneously but in different frequency and/or spatial resources, as illustrated in FIG. 11. As described above, the trigger frame (1100 in FIG. 11) transmitted in step 1010 may comprise at least two resource unit allocations, sharing the same duration. The first direct wireless link may be identified with the association identifier of the first direct wireless link, and a RU Allocation field may be set to ‘66’, for example, meaning a 40 MHz bandwidth formed by the channels 3 and 4 is allocated to the PPDU(s) transmitted by the terminal device 100. The second direct wireless link may be identified with the association identifier of the second direct wireless link, and a RU Allocation field may be set to ‘65’, for example, meaning that another 40 MHz bandwidth, formed by channels 1 and 2 is allocated to the PPDU(s) transmitted by the terminal device 104. In other embodiments, the channels and bandwidths may differ. Accordingly, the terminal device 100 may transmit a first PPDU 1102 to the terminal device 102 on channels 3 and 4, and the terminal device 104 may transmit, simultaneously, a second PPDU 1104 to the terminal device 106 on channels 1 and 2. The terminal devices 102 and 106 may acknowledge the reception of the PPDUs on the respective channels or on one of the channels where the respective PPDUs 1102, 1104 were received. If the duration allows, the terminal devices 100, 104 may transmit further PPDUs 1106, 1108 in an analogous manner.

In summary, in the embodiment of FIGS. 10 and 11 the access node receives, multiple buffer status reports indicating multiple sidelinks and allocates a unique resource unit to each sidelink. Difference to the embodiment of FIGS. 8 and 9 is that the intended recipients are not the same but different terminal devices 102 and 106. The resource units may be arranged to have the same timing, e.g. a start time and duration. Thereafter, the access node may add the resource unit allocations to the same trigger frame.

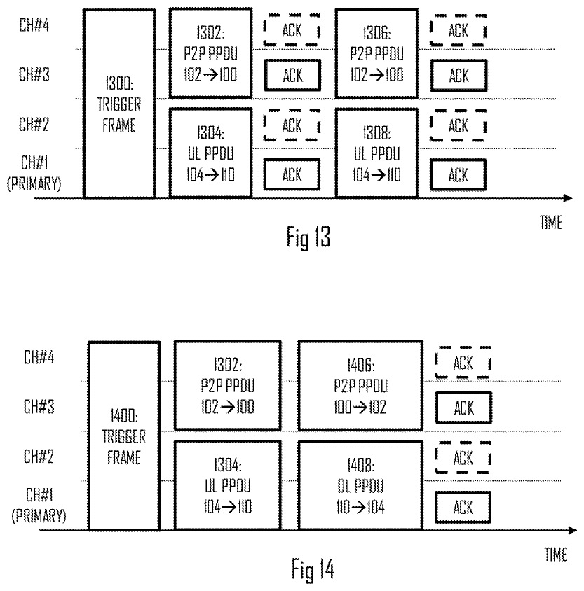

FIGS. 12 to 14 illustrate embodiments where the trigger frame transmitted by the access node indicates a resource unit allocation to at least one direct wireless link and a resource unit allocation to a link between the access node and a terminal device. In these embodiments, the access node 110 receives buffer status reports for both a direct wireless links and a link with the access node, allocates a resource unit to both links and indicates the resource unit allocation in a trigger frame. Referring to FIG. 12, terminal devices 100, 102, 104 may have an association with the access node, as in the embodiments above. Furthermore, terminal devices 100, 102 may have established a direct wireless link therebetween.

Upon determining to transmit data to the terminal device 100, the terminal device 102 may transmit the message comprising the buffer status report to the access node and indicate the respective direct wireless link in the buffer status report (step 1202). The access node may acknowledge the message in step 1204. Thereafter, e.g. upon expiry of the DIFS from the acknowledgment in step 1004, the terminal device 104 also needing to transfer data, to the access node 110, may transmit a message comprising a buffer status report of the terminal device 104 and indicating the link with the access node (step 1206). The indication may be a specific value in the information element ‘P2P mode’ described above. The association identifier of a sidelink may be thus omitted. The access node may acknowledge reception of this message as well (step 1208).

Upon receiving the multiple buffer status reports from the terminal devices 102 and 104, indicating the respective links, one of which is the direct wireless link established in step 1200, the access node 110 may perform allocation of resource units to the direct wireless links and transmit a trigger frame (step 1210) comprising multiple resource unit allocations: one for the direct wireless link and the terminal device 102 and one for the link with the access node and the terminal device 104. Each resource unit allocation may be identified in the trigger frame by the respective association identifier.

Upon receiving the trigger frame in step 1210, the terminal device 102 may detect, on the basis of the detection of the association identifier of the direct wireless link, that the trigger frame comprises a resource unit allocation to the direct wireless link and determines the resource unit allocated to it. Following the user information field illustrated in the Table above, the terminal device 102 may decode the first association identifier first and, upon detecting that the value is the same as an association identifier of the association between the terminal device and the access node, decode the resource unit allocation element. The terminal device may then continue to decode other elements of the field. Upon detecting the element ‘P2P Mode’ indicating the direct wireless link, the terminal device will gain the information that the resource unit allocation is for a direct wireless link. Proceeding with the decoding to the target AID, decoding the Target AID element will provide the terminal device with the information on the particular direct wireless link concerned.

Similarly upon receiving the trigger frame, the terminal device 104 may detect, on the basis of the detection of the association identifier of the link with the access node and that no sidelink is indicated, e.g. the ‘P2P mode’ having the opposite value, that the trigger frame comprises a resource unit allocation to perform uplink transmission to the access node and determines the resource unit allocated to it. Accordingly, the terminal devices 102 and 104 may transmit PPDUs to the respective recipients 100 and 110 in the allocated resource units (step 1212 and 1214). The terminal device 100 may acknowledge the reception of the PPDU in step 1016, and the access node may acknowledge the reception of the PPDU to the terminal device 104 in step 1218. Further PPDUs and respective acknowledgments may be transmitted in steps 1220, 1222, 1224, 1226, if the durations of the TXOPs allow it.

The terminal devices 102, 104 may both have a TXOP simultaneously but in different frequency and/or spatial resources, as illustrated in FIG. 13. As described above, the trigger frame (1300 in FIG. 13) transmitted in step 1210 may comprise at least two resource unit allocations, sharing the same duration. The direct wireless link may be identified with the association identifier of the direct wireless link, and a RU Allocation field may be set to ‘66’, for example, meaning a 40 MHz bandwidth formed by the channels 3 and 4 is allocated to the PPDU(s) transmitted by the terminal device 102. The link with the access node may be identified with the association identifier of the association between the terminal device 104 and the access node 110 and no indication of a sidelink, and a RU Allocation field may be set to ‘65’, for example, meaning that another 40 MHz bandwidth, formed by channels 1 and 2 is allocated to the PPDU(s) transmitted by the terminal device 104. In other embodiments, the channels and bandwidths may differ. Accordingly, the terminal device 102 may transmit a first PPDU 1302 to the terminal device 100 on channels 3 and 4, and the terminal device 104 may transmit, simultaneously, a second PPDU 1104 to the access node 110 on channels 1 and 2. The terminal device 100 and the access node 110 may acknowledge the reception of the PPDUs on the respective channels or on one of the channels where the respective PPDUs 1302, 1304 were received. If the duration allows, the terminal devices 102, 104 may transmit further PPDUs 1306, 1308 in an analogous manner.

In summary, in the embodiment of FIGS. 10 and 11 the access node receives, multiple buffer status reports, one indicating a sidelink and another indicating a link with the access node, and allocates a unique resource unit to each link. The resource units may be arranged to have the same timing, e.g. a start time and duration. Thereafter, the access node may add the resource unit allocations to the same trigger frame.

FIG. 14 illustrates an embodiment using uplink-downlink cascading during the TXOP in the embodiment of FIG. 12. Instead of transmitting the multiple cascaded PPDUs to the same direction (sidelink or uplink), cascaded PPDUs may be transmitted to opposite directions. In order to enable such uplink-downlink cascading, the terminal device(s) sending the buffer status report may indicate or have indicated capability to uplink-downlink cascading, e.g. via an information element ‘multi-user (MU) cascading support’ in a medium access control (MAC) capability information field. The access node may perform the resource unit allocation in the same manner as in FIG. 12. However, instead of exchange of only the acknowledgment frames responsive to the PPDUs 1302, 1304 transmitted as described above in connection with FIG. 13, the subsequent PPDUs 1406, 1408 may be transmitted by the recipients of the PPDUs 1302, 1304, respectively. In other words, the terminal device 100 may transmit the PPDU 1406 to the terminal device 102 on the same frequency channel(s) as the PPDU 1302, and the access node 110 may transmit the PPDU 1408 to the terminal device 104 on the same frequency channel(s) as the PPDU 1304. The PPDUs 1406, 1408 may also carry acknowledgments to the respective PPDUs 1302, 1304. The exchange of the multiple cascaded PPDUs may be followed by the acknowledgment message(s) at the end of the TXOP when no further PPDUs are transmitted.

The uplink-downlink cascading may be applied to the other embodiments of FIGS. 4 to 11 in a straightforward manner.

In the embodiments described above, the access node allocates the same resource units to multiple links according to multi-user communication principles. The embodiments are mainly described in the context where different frequency channels are allocated to the different links but, alternatively or additionally, different spatial multiplexing channels may be allocated to the different links. In other words, multiple links are enabled to transmit simultaneously in the wireless network managed by the access node, in different frequency and/or spatial resources. The access node may employ conventional principles for determining the resource allocations by using the multi-user communications. A simplified embodiment is that the access node allocates a resource unit only to a single direct wireless link and none of the other links in the wireless network have a resource unit allocated to the same time interval. In other words, only a single TXOP is valid in the wireless network (for the direct wireless link).

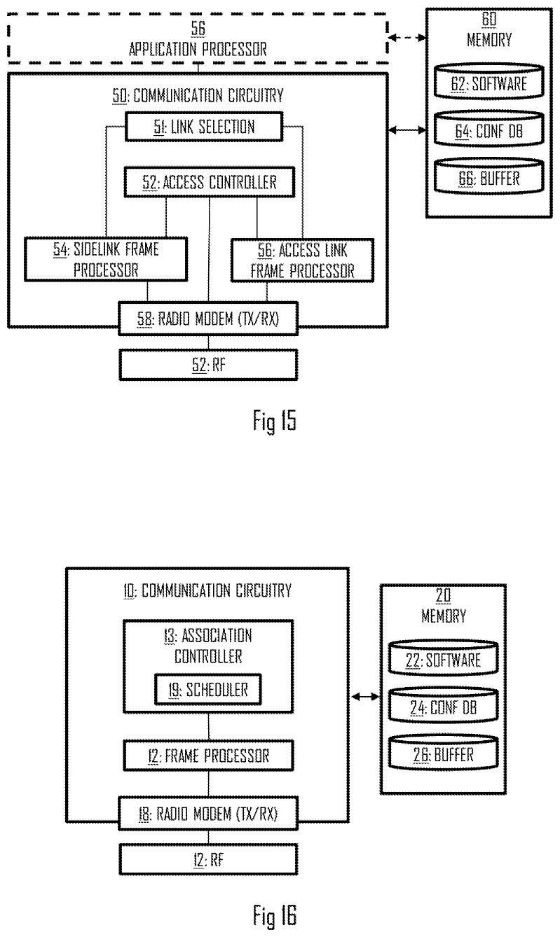

FIG. 15 illustrates an embodiment of a structure of the above-mentioned functionalities of an apparatus executing the functions of the apparatus in the process of FIG. 2 or any one of the embodiments of FIG. 2 described above. The apparatus may be a wireless device such as any one of the terminal devices 100 to 106. The apparatus may comply with 802.11 specifications or specifications of another wireless network. The apparatus may be or may be comprised in a computer (PC), a laptop, a tablet computer, a cellular phone, a palm computer, a sensor device, a router device, or any other apparatus provided with radio communication capability. In another embodiment, the apparatus carrying out the process of FIG. 2 or any one of its embodiments is comprised in such a wireless device, e.g. the apparatus may comprise a circuitry, e.g. a chip, a chipset, a processor, a micro controller, or a combination of such circuitries in the wireless device. The apparatus may be an electronic device comprising electronic circuitries for realizing some embodiments of the wireless device.

Referring to FIG. 15, the apparatus may comprise a communication circuitry 50 providing the apparatus with capability of communicating in at least one wireless network. The communication circuitry may employ a radio interface providing the apparatus with radio communication capability. The radio interface may comprise a radio modem 58 and radio frequency (RF) circuitries 52 providing at least a part of the above-described physical layer(s) of the wireless device. The radio interface may be comprised in the apparatus in the embodiments where the apparatus is the wireless device. In other embodiments where the apparatus is a chipset for the wireless device, the radio interface may be external to the apparatus. The radio interface may support frame (e.g. PPDU) transmission and reception according to the principles described above. The RF circuitries 52 may comprise radio frequency converters and components such as an amplifier, filter, and one or more antennas. The radio modem 58 may comprise baseband signal processing circuitries such as (de)modulator and encoder/decoder circuitries.

In embodiments where the apparatus is the STA 100 or a similar client device or terminal device, the apparatus may further comprise an application processor 56 executing one or more computer program applications that generate a need to transmit and/or receive data through the communication circuitry 50. The application processor may form an application layer of the apparatus. The application processor may execute computer programs forming the primary function of the apparatus. For example, if the apparatus is a sensor device, the application processor may execute one or more signal processing applications processing measurement data acquired from one or more sensor heads. If the apparatus is a computer system of a vehicle, the application processor may execute a media application and/or an autonomous driving and navigation application. The application processor may generate data to be transmitted in the wireless network.

As described above, the apparatus and the communication circuitry may be configured to establish the association with the access node and, additionally, one or more sidelinks linked to the association via the TDLS or a similar sidelink protocol. The apparatus may comprise a link selection circuitry 51 configured to determine, upon receiving data from the application processor, whether the data shall be transmitted to the access node or via a sidelink. For example, if the data is addressed to another terminal device with which the apparatus has established a sidelink, the link selection circuitry 51 may forward the data to a sidelink frame processor 54. Otherwise, the link selection circuitry 51 may forward the data to an access link frame processor 56. The access link may refer to the (wireless) link between the apparatus and the access node. The frame processors 54, 56 may perform frame generation for transmission and extraction of received frames. An access controller 52 may control the frame processors and the radio modem in channel access, e.g. in channel contention or trigger-based transmission. For example, upon detecting the data to be transmitted, the access controller may generate the buffer status report in the above-described manner. If the data is for the sidelink, the access controller 52 may control the access link frame processor to generate a frame carrying a buffer status report indicating the sidelink. If the data is for the access link, the access controller 52 may control the access link frame processor to generate a frame carrying a buffer status report indicating the access link. Upon receiving the trigger frame, the access controller may control the transmission in the resource unit allocated to the apparatus, as described in the embodiments above.

The apparatus may further comprise a memory 60 storing one or more computer program products 62 configuring the operation of said processor(s) of the apparatus. The memory 60 may further store a configuration database 64 storing operational configurations of the apparatus. The configuration database 64 may store, for example, the configurations of the access link and the sidelink. The memory 60 may further store a data buffer 66 for data to be transmitted.

FIG. 16 illustrates an embodiment of a structure of the above-mentioned functionalities of an apparatus executing the functions of the apparatus in the process of FIG. 3 or any one of the embodiments of FIG. 3 described above. The apparatus may be a wireless device such as the access node 110. The apparatus may comply with 802.11 specifications or specifications of another wireless network. The apparatus may be or may be comprised in a computer (PC), a laptop, a tablet computer, a cellular phone, a palm computer, a sensor device, a router device, or any other apparatus provided with radio communication capability. In another embodiment, the apparatus carrying out the process of FIG. 3 or any one of its embodiments is comprised in such a wireless device, e.g. the apparatus may comprise a circuitry, e.g. a chip, a chipset, a processor, a micro controller, or a combination of such circuitries in the wireless device. The apparatus may be an electronic device comprising electronic circuitries for realizing some embodiments of the wireless device.

Referring to FIG. 10, the apparatus may comprise a communication circuitry 10 providing the apparatus with capability of communicating in at least one wireless network. The communication circuitry may employ a radio interface providing the apparatus with radio communication capability. The radio interface may comprise a radio modem 18 and radio frequency (RF) circuitries 12 providing at least a part of the above-described physical layer(s) of the wireless device. The radio interface may be comprised in the apparatus in the embodiments where the apparatus is the wireless device. In other embodiments where the apparatus is a chipset for the wireless device, the radio interface may be external to the apparatus. The radio interface may support frame transmission and reception according to the principles described above. The RF circuitries 12 may comprise radio frequency converters and components such as an amplifier, filter, and one or more antennas. The radio modem 18 may comprise baseband signal processing circuitries such as (de)modulator and encoder/decoder circuitries.

The apparatus may further comprise a frame processor 12 configured to generate frames for transmission and to extract contents of received frames. The apparatus may further comprise an association controller 13 configured to manage associations with terminal devices associated to the access node. The association controller 13 may comprise a scheduler configured to perform the resource unit allocations according to any one of the above-described embodiments, for both the access links and the sidelinks in the network managed by the access node. Upon receiving a buffer status report from a terminal device, extracted from a frame by the frame processor 12, the association controller may determine the link(s) to which the resource allocation is requested and instruct the scheduler to allocate the resource unit(s) to the link(s). Upon performing the resource allocation, the association controller 13 may control the frame processor to generate a trigger frame indicating the resource unit allocation according to any one of the above-described embodiments.

The apparatus may further comprise a memory 20 storing one or more computer program products 22 configuring the operation of said processor(s) of the apparatus. The memory 20 may further store a configuration database 24 storing operational configurations of the apparatus. The configuration database 24 may store, for example, the configurations of the access links and sidelinks established in the wireless network. The memory 60 may further store a buffer 26 for data to be transmitted.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 14 may also be carried out in the form of one or more computer processes defined by one or more computer programs. A separate computer program may be provided in one or more apparatuses that execute functions of the processes described in connection with the Figures. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1-31. (canceled)

32. An apparatus comprising:
at least one processor; and
at least one memory storing instructions that, when executed by the at least one processor, cause the apparatus at least to:
establish using a first terminal device an association with an access node;
establish a direct wireless link with a second, non-access-node, terminal device;
cause transmission of a message to the access node, the message comprising a buffer status report and at least one information element indicative of the direct wireless link;
receive, in response to the message, a trigger frame indicative of a resource unit allocated to the direct wireless link;
in response to the trigger frame, cause transmission of a data packet to the second terminal device over the direct wireless link in the allocated resource unit.

33. The apparatus of claim 32, wherein the at least one information element indicative of the direct wireless link comprises an identifier of the direct wireless link.

34. The apparatus of claim 32, wherein the at least one information element indicative of the direct wireless link comprises a channel quality indicator indicative of a channel quality of the direct wireless link.

35. The apparatus of claim 32, wherein the at least one information element indicative of the direct wireless link comprises an indicator of a peer-to-peer transmission mode of the apparatus.

36. The apparatus of claim 32, wherein the resource unit comprises a time-frequency transmission resource.

37. The apparatus of claim 32, wherein the trigger frame comprises an information element indicative of the direct wireless link.

38. The apparatus of claim 32, wherein further configured to:
establish a further direct wireless link with a third, non-access-node, terminal device;
after transmitting the message and before receiving the trigger frame, transmitting a further message to the access node, the further message comprising a further buffer status report and at least one information element indicating the further direct wireless link,
wherein the trigger frame indicates, in addition to the resource unit allocated to the direct wireless link, a further resource unit allocated to the further direct wireless link;
in response to the trigger frame, causing transmission of a further data packet to the third terminal device over the further direct wireless link in the further resource unit.

39. An apparatus comprising:
at least one processor; and
at least one memory storing instructions that, when executed by the at least one processor, cause the apparatus at least to:
establish, using an access node of a wireless network, an association with a first terminal device;
receive a message from the first terminal device, the message comprising a buffer status report of the first terminal device and at least one information element indicative of a direct wireless link between the first terminal device and a second terminal device;
allocate, in response to the message, a resource unit to the direct wireless link; and
cause transmission of a trigger frame to the first terminal device, the trigger frame indicative of the resource unit and the direct wireless link.

40. The apparatus of claim 39, further configured to:
receive from the first terminal device, a further buffer status report and at least one information element indicating a further direct wireless link;
allocate, in response to the further buffer status report, a further resource unit to the further direct wireless link,
wherein the trigger frame indicates, in addition to the resource unit allocated to the direct wireless link, a further resource unit allocated to the further direct wireless link.

41. The apparatus of claim 39, further configured to:
establish an association with a third terminal device;
after receiving the message and before transmitting the trigger frame, receiving a further message from a third terminal device, the further message comprising a further buffer status report and at least one information element indicating a further direct wireless link between the third terminal device and the second terminal device;
allocate, in response to the further message, a further resource unit to the further direct wireless link,
wherein the trigger frame indicates, in addition to the resource unit allocated to the direct wireless link, a further resource unit allocated to the further direct wireless link.

42. The apparatus of claim 39, further configured to:
establish an association with a third terminal device;
after receiving the message and before transmitting the trigger frame, receiving a further message from the third terminal device, the further message comprising a further buffer status report and at least one information element indicating a further direct wireless link between the third terminal device and a fourth terminal device;
allocate, in response to the further message, a further resource unit to the further direct wireless link,
wherein the trigger frame indicates, in addition to the resource unit allocated to the direct wireless link, a further resource unit allocated to the further direct wireless link, wherein the resource unit and the further resource unit specify the same time resource but a different frequency resource or a different spatial multiplexing resource.

43. The apparatus of claim 39, further configured to:
establish an association with a third terminal device;
after receiving the message and before transmitting the trigger frame, receive a further message from the third terminal device, the further message comprising a further buffer status report and at least one information element indicating an access link between the third terminal device and the access node;
allocate in response to the further message, a further resource unit to the access link,
wherein the trigger frame indicates, in addition to the resource unit allocated to the direct wireless link, the further resource unit allocated to the access link, wherein the resource unit and the further resource unit specify the same time resource but a different frequency resource or a different spatial multiplexing resource.

44. A method, comprising:
establishing, by a first terminal device, an association with an access node;
establishing, by the first terminal device, a direct wireless link with a second, non-access-node, terminal device;
causing by the first terminal device transmission of a message to the access node, the message comprising a buffer status report and at least one information element indicating the direct wireless link;
receiving, by the first terminal device in response to the message, a trigger frame indicating a resource unit allocated to the direct wireless link;
in response to the trigger frame, causing by the first terminal device transmission of a data packet to the second terminal device over the direct wireless link in the allocated resource unit.

45. The method of claim 44, wherein the at least one information element indicating the direct wireless link comprises an identifier of the direct wireless link.

46. The method of claim 44, wherein the at least one information element indicating the direct wireless link comprises a channel quality indicator indicating a channel quality of the direct wireless link.

47. The method of claim 44, wherein the at least one information element indicating the direct wireless link comprises an indicator of a peer-to-peer transmission mode of the apparatus.

48. The method of claim 44, wherein the trigger frame comprises an information element indicating the direct wireless link.

49. The method of claim 44, further comprising as performed by the first terminal device:
establishing a further direct wireless link with a third, non-access-node, terminal device;
after transmitting the message and before receiving the trigger frame, transmitting a further message to the access node, the further message comprising a further buffer status report and at least one information element indicating the further direct wireless link,
wherein the trigger frame indicates, in addition to the resource unit allocated to the direct wireless link, a further resource unit allocated to the further direct wireless link;
in response to the trigger frame, causing transmission of a further data packet to the third terminal device over the further direct wireless link in the further resource unit.

50. The method of claim 49, wherein the resource unit and the further resource unit specify the same time resource but a different frequency resource or a different spatial multiplexing resource.

51. A method, comprising:
establishing, by an access node of a wireless network, an association with a first terminal device;
receiving by the access node a message from the first terminal device, the message comprising a buffer status report of the first terminal device and at least one information element indicating a direct wireless link between the first terminal device and a second terminal device;
in response to the message, allocating by the access node a resource unit to the direct wireless link and causing transmission of a trigger frame to the first terminal device, the trigger frame indicating the resource unit and the direct wireless link.

52. A computer program product embodied on a computer-readable medium and comprising a computer program code readable by a computer for a first network node of a wireless network, wherein the computer program code configures the computer to carry out a computer process in a first terminal device, the computer process comprising:
establishing an association with an access node;
establishing a direct wireless link with a second, non-access-node, terminal device;
causing transmission of a message to the access node, the message comprising a buffer status report and at least one information element indicating the direct wireless link;
receiving, in response to the message, a trigger frame indicating a resource unit allocated to the direct wireless link;
in response to the trigger frame, causing transmission of a data packet to the second terminal device over the direct wireless link in the allocated resource unit.
